(19) United States
(12) Patent Application Publication
(10) Pub. No.: US 2026/0210700 A1
(43) Pub. Date: Jul. 23, 2026

(54) ORIENTATIONAL COLOR-BASED DEFORMATION SENSOR AND SYSTEMS AND METHODS USING THE SAME

(71) Applicant: Toyota Research Institute, Inc., Los Altos, CA (US)

(72) Inventors: Aimee Goncalves, Kingston, MA (US); Jose Barreiros, Somerville, MA (US); Naveen Suresh Kuppuswamy, Arlington, MA (US)

(73) Assignees: Toyota Research Institute, Inc., Los Altos, CA (US); Toyota Jidosha Kabushiki Kaisha, Aichiken (JP)

(21) Appl. No.: 19/029,605

(22) Filed: Jan. 17, 2025

(51) Int. Cl. G01B 11/16; B25J 13/08; G01B 11/22

(52) U.S. Cl. CPC G01B 11/16; B25J 13/081; G01B 11/22

(57) ABSTRACT

A deformation sensor disclosed herein may include a plurality of three-dimensional (3D) objects arranged on a deformable membrane and an optical sensor. Each 3D object includes two or more colored parts. The colored parts include two or more colors. At least one pair of neighbor colored parts includes different colors. The optical sensor is configured to image the 3D objects to determine a deformation of the deformable membrane based on a color distribution of the 3D objects.

### TECHNICAL FIELD

Embodiments described herein generally relate to contact sensors and, more particularly, to deformable contact and geometry/pose sensors capable of detecting contact and a geometry of an object.

### BACKGROUND

Robots designed for object manipulation frequently struggle with fine force control, adapting to unexpected environmental changes, and interacting with delicate or irregularly shaped objects in a precise manner. Accordingly, a need exists for improved robots.

### SUMMARY

In one embodiment, a deformation sensor includes a plurality of three-dimensional (3D) objects arranged on a deformable membrane and an optical sensor. Each 3D object includes two or more colored parts. The colored parts include two or more colors. At least one pair of neighbor colored parts includes different colors. The optical sensor is configured to image the 3D objects to determine a deformation of the deformable membrane based on a color distribution of the 3D objects.

In another embodiment, a method for measuring a deformation using a deformation sensor includes imaging, using an optical sensor, a color distribution of a plurality of three-dimensional (3D) objects disposed on a deformable membrane, each 3D object comprising two or more colored parts, generating real-time proximity depths of the 3D objects based on the color distribution of the 3D objects, and determining a deformation of the deformable membrane at least partially based on the real-time proximity depths and historical proximity depths of the 3D objects. The colored parts include two or more colors. At least one pair of neighbor colored parts comprises different colors. The color distribution comprises one or more captured colors for each 3D object.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and example in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a cross-sectional view of an example deformation sensor assembly including a plurality of three-dimensional (3D) objects, according to one or more embodiments described and illustrated herein;

FIG. 2 depicts non-limiting components of an example deformation sensor assembly, according to one or more embodiments shown and described herein;

FIG. 3A schematically depicts a top perspective view of an example 3D object having a base part and an optical part, according to one or more embodiments described and illustrated herein;

FIG. 3B schematically depicts a left-side perspective view of the example 3D object in FIG. 3A, according to one or more embodiments described and illustrated herein;

FIG. 3C schematically depicts a back-side perspective view of the example 3D object in FIG. 3A, according to one or more embodiments described and illustrated herein;

FIG. 3D schematically depicts a top perspective view of an example array of the 3D objects having the base parts and the optical parts, according to one or more embodiments described and illustrated herein;

FIG. 4A schematically depicts a top perspective view of an example 3D object having a polygonal base pyramid shape, according to one or more embodiments described and illustrated herein;

FIG. 4B schematically depicts a left-side perspective view of the example 3D object in FIG. 4A, according to one or more embodiments described and illustrated herein;

FIG. 4C schematically depicts a back-side perspective view of the example 3D object in FIG. 4A, according to one or more embodiments described and illustrated herein;

FIG. 5 schematically depicts a cross-sectional view of an example deformed deformation sensor assembly including the plurality of three-dimensional (3D) objects, according to one or more embodiments described and illustrated herein;

FIG. 6 schematically depicts a rear perspective view of a bubble module of the example deformation sensor of FIG. 1, according to one or more embodiments described and illustrated herein;

FIG. 7 schematically depicts an example robot including an end effector having a plurality of fingers and an example deformation sensor on each finger according to one or more embodiments described and illustrated herein;

FIG. 8 schematically depicts two example robots each having a deformation sensor and manipulating an object, according to one or more embodiments described and illustrated herein;

FIG. 9 schematically depicts an example robot having a plurality of deformation sensors with varying spatial resolution and depth resolution;

FIG. 10 depicts non-limiting components of an example robot, according to one or more embodiments shown and described herein; and

FIG. 11 is a flow chart depicting an example process of determining deformation using a deformation sensor according to one or more embodiments described and illustrated herein.

### DETAILED DESCRIPTION

As humans, our sense of touch allows us to determine the shape of an object without looking at the object. Further, our sense of touch provides information as to how to properly grasp and hold an object. Our fingers are more sensitive to touch than other parts of the body, such as arms. This is because we manipulate objects with our hands.

Robots are commonly equipped with end effectors that are configured to perform certain tasks. For example, an end effector of a robotic arm may be configured as a human hand, or as a two-fingered gripper. However, robots do not have varying levels of touch sensitivity as do humans. End effectors may include sensors such as pressure sensors, but such sensors provide limited information about the object that is in contact with the end effector. Thus, the robot may damage a target object by using too much force, or drop the object because it does not properly grasp the object.

To overcome these limitations, embodiments directed to a deformation sensor, which contains three-dimensional (3D) objects arranged on a deformable membrane, are provided. This deformation sensor is capable of providing real-time feedback on the deformation of the surface of the sensor, allowing the robot to monitor its interactions with objects more closely. The 3D objects may include two or more colored parts of two or more colors. Detected colors of the 3D objects is orientation-dependent. Thus, by monitoring the positions, color profiles (number of colors, connection pattern of the colors, and areas of the colors), and/or the orientation of the 3D objects on the deformable membrane, the deformation sensor enables the robot to dynamically adjust its actions based on the current state of its environment. This capability not only helps prevent unintended collisions, but also improves the robot's precision when handling complex or delicate tasks. Integrating such a deformation sensor with the robot's manipulation system would greatly enhance the robot's ability to operate effectively in dynamic environments. The sensor's feedback mechanism allows the robot to adapt quickly to unforeseen changes, ensuring smooth and efficient task execution. As a result, the robot can achieve a higher level of performance, especially in applications that require careful manipulation of fragile, flexible, or unevenly shaped objects. By improving the robot's adaptability and control, the deformation sensor with 3D objects serves as a crucial advancement in robotic technology, enabling more sophisticated and reliable operation in a variety of complex scenarios.

Embodiments of the present disclosure are directed to deformable/compliant contact and/or geometry/deformation sensors (hereinafter “deformation sensors”) that not only detect contact with a target object but also detect the geometry, pose and contact force of the target object. Particularly, the deformation sensors described herein may include a bubble module. The deformation sensors include a deformable membrane and a bottom surface to define a cavity therein, a plurality of 3D objects along with an elastic medium filled within the cavity, and a camera to track the positions and color profiles of the 3D objects such that the deformation sensors can detect a displacement or a deformation of the deformable membrane when external forces applied. Thus, the deformation sensors described herein provide a robot or any manipulation devices with a sense of touch when manipulating or contacting external objects.

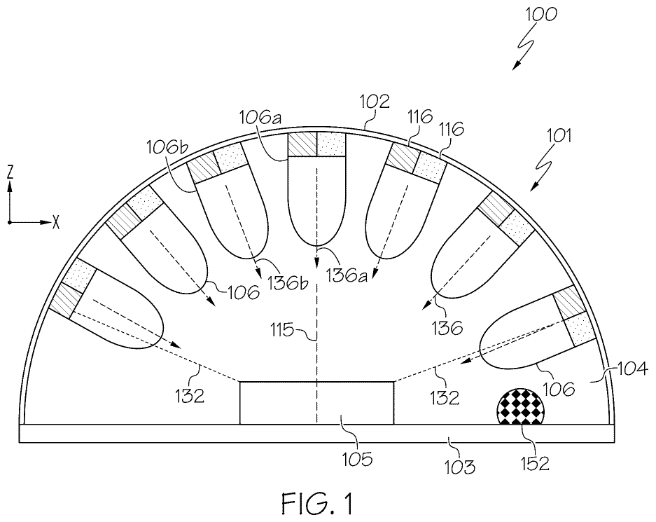

Referring now to the figures, FIG. 1 schematically depicts an example deformation sensor assembly 100 in a side view. The example deformation sensor assembly 100 generally includes a deformable membrane 102 and a plurality of the 3D objects 106 arranged on the deformable membrane 102. The deformable membrane 102 may be flexible and deformable. Each 3D object 106 includes two or more colored parts 116. Each colored part 116 may have a color, and at least one pair of neighbor colored parts 116 includes different colors. The color profile of each 3D object 106 may depend on an orientation angle of a corresponding 3D object 106 with respect to an observation position (e.g. a position of an optical sensor 105). For example, in some embodiments, for 3D objects with two colored parts 116 with equal colored areas, the color profile at a top of a vertical orientation may include all two colors with areas proportional to original color portions (e.g., 1:1 for two colors). The color profile changes as the orientation angle strays away from the top of the vertical orientation, leading to a partial view of one color while a full view of another color, which causes a decreasing color portion for the partial-view colored part 116 (e.g., 1:0.5 for a full-view colored part and a partial-view colored part). In some embodiments, as the observation position further strays away, the area of the partial view colored portion may further decrease to none (e.g., 1:0 for a full-view colored part and a partial-view colored part). Thus, an orientation angle and/or proximity distance between the observation position and a 3D object 106 can be determined by recording the color profile of the corresponding 3D object 106.

As in FIG. 1, the optical sensor 105 is used to image the 3D objects to determine positions, color profiles, and/or orientations of the 3D objects 106. The optical sensor 105 may have a central axis 115 referring to an axis to receive lights. Each 3D object 106 may include an inclined axis 136 reflecting the orientation of the 3D object 106. A color profile of a 3D object 106 from a viewpoint aligned with the inclined axis 136 may include all the colors having areas proportional to the original color portions of the colored parts 116 in the corresponding 3D object 106. When the deformable membrane 102 is deformed, the orientations of the 3D objects 106 may change accordingly to reflect the deformation of the deformable membrane 102. The color distribution of the 3D objects 106 may include one or more captured colors for each 3D object 106, and the one or more captured colors of a corresponding 3D object 106 may depend on an orientation angle between the optical sensor 105 and the corresponding 3D object 106. In some embodiments, the orientation angle of one of the 3D objects 106 may refer to an angle between an inclined axis 136 of the corresponding 3D object 106 and the central axis 115 of the optical sensor 105. The one or more captured colors of the corresponding 3D object 106 may be a subgroup of the colors of the corresponding 3D object 106. In some embodiments, the deformation sensor assembly 100 may further determine a proximity depth of the corresponding 3D object 106 based on the one or more captured colors of the corresponding 3D object 106. Accordingly, an image of the color distribution of the 3D objects 106 can reflect the deformation of the deformable membrane 102.

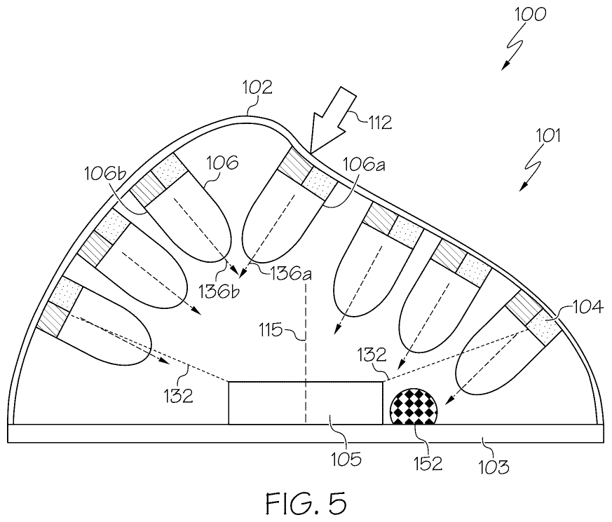

Referring to FIGS. 1 and 5, the optical sensor 105 may capture the color profiles of the 3D objects 106 including the number of colors, the color patterns, and the color areas of each color. The color profiles may be used to determine the orientation angles between the 3D objects 106 and the optical sensor 105. For example, the 3D objects 106 may include two colored parts 116 with equal colored areas. As illustrated in FIG. 1, when no external force 112 is applied, the 3D object 106a has an inclined axis 136a aligned with the central axis 115 of the optical sensor 105, and the 3D object 106b has the inclined axis 136 b of which is away from the central axis 115. The orientation angle between the 3D object 106a and the optical sensor 105 is zero degrees, and the orientation angle between the 3D object 106b and the optical sensor 105 is less than zero degrees (e.g., −20 degrees). The color profile of the 3D object 106a may include two captured colors with equal areas, and the color profile of the 3D object 106 b may include one captured color or two captured colors with unequaled areas. As illustrated in FIG. 5, when the external force 112 is applied, the shape of the deformable membrane 102 changes, causing the inclined axes 136 of the 3D objects 106 to tilt from the original direction. For example, the inclined axis 136a may title to the right and the inclined axis 136b may tile to further left, leading to a positive orientation angle (e.g., 30 degrees) of the 3D object 106a and a further negative orientation angle (e.g., −45 degrees) of the 3D object 106b. The color profiles of the 3D objects 106a and 106b may change according to the change of the orientation angles of the 3D objects 106a and 106b, respectively.

In some embodiments, as in FIGS. 1 and 5, the deformation sensor assembly 100 may include a bubble module 101. The bubble module 101 may include a deformable membrane 102 and a bottom surface 103. The bottom surface 103 may be rigid and/or undeformable. The deformable membrane 102 may be coupled to the bottom surface 103 to define a cavity 104. The cavity 104 may be filled with a plurality of 3D objects 106. The 3D objects 106 in the cavity 104 may be mechanically attached to the deformable membrane 102 such that the deformable membrane 102 may form a dome shape as shown in FIG. 1. It should be appreciated that any suitable shape, such as, without limitation, a flat shape, of the deformable membrane 102 may be utilized in other embodiments. In some embodiments, the deformable membrane 102 may attach to an interested object to resemble the surface of the interested object, such as a soft surface seat. In some embodiments, the cavity 104 may further include an elastic medium in space not occupied by the 3D objects 106. The deformation sensor assembly 100 may include one or more position sensors, such as vision sensors, proximity sensors, or a camera, configured to determine positions, color profiles, and/or orientations of the 3D objects 106, which are further used to determine a displacement and deformation of the deformable membrane 102. In embodiments, the position sensors may be positioned within the bubble module 101, such as an optical sensor 105 mechanically coupled to an inner surface of the bottom surface 103. It should be appreciated that in some other embodiments, one or more of the position sensors may be placed outside of the bubble module 101. When an external force 112 (e.g., as in FIG. 5) is applied to the deformable membrane 102 causing a deformation of the deformable membrane 102, for example during contact with an object, the 3D objects 106 may move and the positions and orientations of the 3D objects 106 may change in a synchronized manner, leading to a change of the positions or color profiles as captured by the optical sensor 105 of the 3D objects 106. The optical sensors 105 may capture the positions and a color distribution of the 3D objects 106 in real-time. The deformation sensor assembly 100 may use the real-time positions and/or the color distributions of the 3D objects 106 to determine the deformation and displacement of the deformable membrane 102. The deformation sensor assembly 100 may further include a light source 152. The light source 152 may be located within the bubble module 101, such as mechanically coupled to the inner surface of the bottom surface 103, an inner surface of the deformable membrane 102, or any place within the cavity 104. The light source 152 may emit light to illuminate the positions and the colors of the 3D objects 106.

In embodiments, the deformable membrane 102 may be flexible. The deformable membrane 102 may be a latex, silicone rubber, thermoplastic elastomers, polyurethane, ethylene vinyl acetate, gel materials, foamed polymers, hydrogels, or any other suitable material, such as a suitably thin, non-porous, rubber-like material. The deformable membrane 102 may be transparent, diaphanous, or opaque. In some embodiments, the deformable membrane 102 may include an optional filter layer. The filter layer may be configured to aid the optical sensor 105 in detecting the deformation of the deformable membrane 102. In some embodiments, the filter layer reduces glare or improper reflections of one or more optical signals emitted by the optical sensor 105 and/or the light source 152. In some embodiments, the filter layer may scatter one or more optical signals emitted by the optical sensor 105. The filter layer may be an additional layer secured to an inner surface of the deformable membrane 102, or it may be a coating and/or pattern applied to the inner surface of the deformable membrane 102.

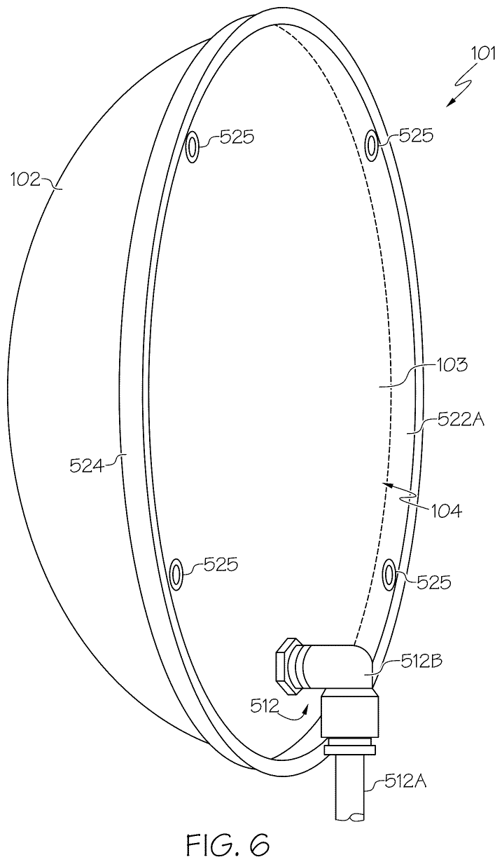

In embodiments, the bottom surface 103 may be rigid and/or undeformable. The bottom surface 103 may provide structure support to the deformable membrane 102, allowing the deformable membrane 102 to deform and adapt to manipulate one or more objects while being supported by a stable, rigid base. The bottom surface 103 may be flat as illustrated in FIGS. 1 and 5 or shaped to accommodate specific design needs. The bottom surface may be a polymer (e.g., acrylic, polycarbonate, polyethylene terephthalate, nylon), metal alloys (e.g., aluminum, stainless steel), composite material (e.g., fiberglass, carbon fiber), ceramics (e.g., alumina), or any suitable materials. The bottom surface 103, as illustrated in FIG. 6, may further include structures to allow deformation sensor assembly 100 to be mechanically coupled to external structures and devices. It should be appreciated that, in some embodiments, the bottom surface 103 may be made of flexible materials, and a mechanical interaction of the bottom surface 103 with an external structure may further provide sufficient support through interactions between the bottom surface 103 and the external structure.

Referring to FIGS. 1 and 3A-5, in embodiments, the 3D objects 106 and the elastic medium may be filled within the cavity 104. The 3D objects 106 and the elastic medium may be transparent, transparent with light diffusion, semi-transparent, semi-opaque, opaque with light permeation, or opaque. The 3D objects 106 and the elastic medium may include material of latex, silicone, optical-grade acrylic, clear plastics, clear glass, low-tint glass, clear polycarbonate, frosted glass, diffusing acrylic, textured plastics, milk glass, translucent plastics, opaque plastics with embedded particles, partially frosted acrylic, thick frosted glass, tinted or colored plastics, thick opaque plastics, dense ceramics, or any materials suitable for the application. The 3D objects 106 and the elastic medium may be cast or 3D printed. The 3D objects 106 and the elastic medium may be doped with salts, minerals, or other materials. The 3D objects 106 may be dispersed in the elastic medium and/or be arranged in a close-packed pattern, with each 3D object 106 in contact with one or more neighbor 3D objects 106. The array of the 3D objects 106 may be arranged with a constant density or a variable density. In some embodiments, the array of the 3D objects 106 may be in a periodic arrangement. The positions of the 3D objects 106 may be repeated periodically on the inner surface of the deformable membrane 102.

In some embodiments, the 3D objects 106 may include two or more colors. The 3D objects 106 may be in the shape of a spherical shape, a rectangular prism shape, a hexagonal prism shape, a pyramid shape, or a combination thereof. The 3D objects 106 may be in different sizes or a uniform size. The 3D objects 106 may be elastic or rigid. The 3D objects 106 may have a Young's Modulus of between around 0.001 GPa to around 10 GPa. For example, the 3D objects 106 may be made of silicone having Young's Modulus of around 0.001 GPa to 0.1 GPa, rubber having Young's Modulus of around 0.01 GPa to around 1 GPa, or polymer, having Young's Modulus of around 2 GPa to around 5 GPa.

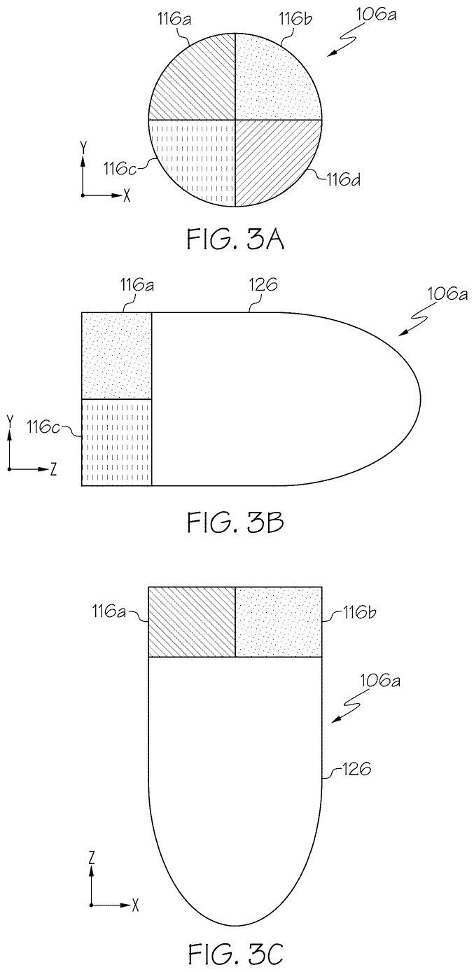

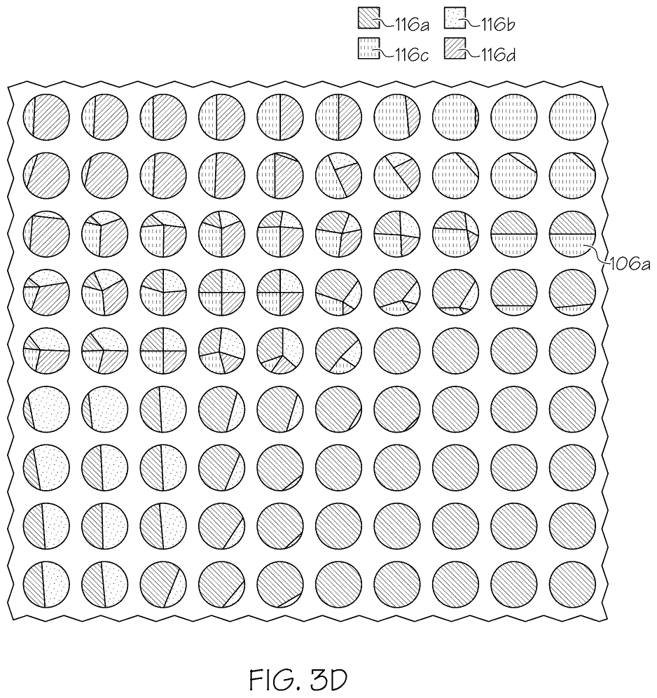

Referring to FIGS. 3A-3D, in some embodiments, each 3D object 106a may include a base part and an optical part 126. The base part includes two or more colored parts 116 (e.g., four colored parts 116a, 116b, 116c, and 116d as in FIGS. 3A-3C). The optical part 126 may be transparent or diaphanous. The optical part 126 may be arranged toward the optical sensor 105. The base part may be attached to the deformable membrane 102 and away from the optical sensor 105. At least some parts of the optical part 126 may include a concave shape, a convex shape, a pyramid shape, a dome shape, or a faceted shape. The optical part 126 may be configured to cause an angle-dependent color viewing of the 3D object 106a based on reflection, refraction, diffraction, or a combination thereof. For example, due to reflection, refraction, or diffraction, each viewing angle may allow only one or two colors from the base part to be visible. At certain angles, the refraction effect may fully direct one color toward the optical sensor 105 while bending others away from view, creating an effect where only one or fewer colors from the colored parts 116 are visible at a time. For example, as in FIG. 3D, a direct top observation of a 3D object 106a in a vertical orientation using the optical sensor 105 may have captured colors with the same color profile as the original color profile in FIG. 3A, namely a quarter circle for each colored parts 116. As the positions of the 3D objects 106a shift further away from the 3D object 106a having the direct top view of the vertical orientation, initially, the portions of two colors of the colored parts 116 gradually decrease. This shift may change the color profile of the captured colors, with more portions of two colors of the other two colored parts 116. Eventually, as the position shift further increases, some of the colors of the colored parts 116 fully vanish, leaving a color profile consisting of only one color being captured by the optical sensor 105.

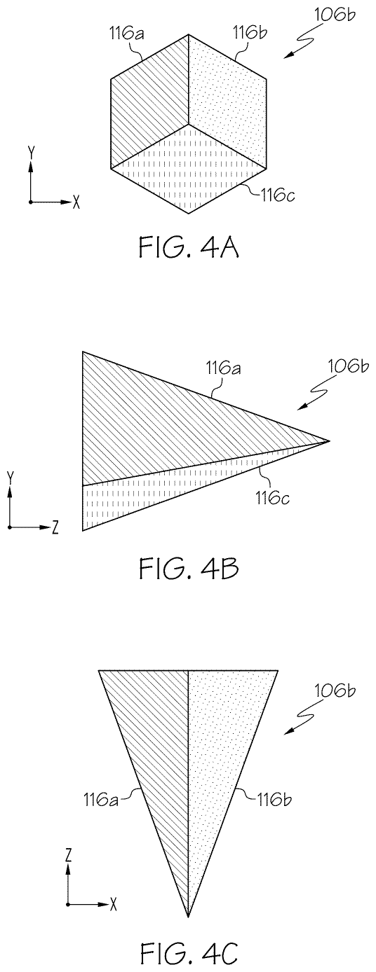

Referring to FIGS. 4A-4C, in some embodiments, the 3D objects 106 b may have 3D shapes, such as, without limitation, a polyhedron shape, a tetrahedron shape, a polygonal base pyramid shape, or a combination thereof. The 3D shapes may include a plurality of facets, with a base facet and two or more exposed facets. The base facet may be configured to be coupled to the deformable membrane 102. The exposed facets may have two or more colors. Each colored part 116 may be one of the facets of the 3D shapes. For example, as in FIGS. 4A-4C, the 3D object 106b has a pyramid shape with a hexagonal base facet and three exposed facets, each exposed facet including a different colored part 116 (i.e., 116a, 116b, and 116c). Each colored part 116 may include a different color than the other colored parts 116. When the optical sensor 105 captures a color profile of the 3D object 106 b, the orientation of the 3D object 106b with respect to the optical sensor 105 can affect the number of visible facets or the colored parts 116, and the proportion of each visible facet or colored part 116. For example, a top view of a vertical orientation with the apex pointing directly toward the optical sensor 105, all three colored parts 116a, 116b, and 116c with a color profile of equal area for each colored part may be captured. A side view of the 3D object 106b may result in two visible triangular facets of colored parts 116. The proportions of each facet visible may be determined by the angles between the optical sensor 105 and the facets of the 3D object 106. The colored part 116 facing the optical sensor 105 may appear larger and fully visible, and the colored part 116 angled away may appear smaller or partially obscured.

Referring back to FIGS. 1 and 5, in some embodiments, the cavity 104 may include an elastic medium in the space not occupied by the 3D objects 106. The elastic medium may be rigid and elastic. The elastic medium may be in a gas phase, in a liquid phase, or in a solid phase. For example, the elastic medium may be a gel, such as silicone or other rubber-like substance. In various embodiments, the elastic medium may be anything that is transparent to one or more optical sensors 105, such as to a wavelength utilized by a time of flight sensor or visible light used by a camera. The elastic medium may include clear/transparent rubbers in some embodiments. In other embodiments, the elastic medium may be a liquid, such as a rigid liquid material, or a mixture of solid and liquid. In some examples, the deformable membrane 102 and the elastic medium within the cavity 104 may be fabricated of the same material, such as, without limitation, silicone. The elastic medium may have a viscosity of between around 1 centipoise (cP) to around 1000 cP, or any viscosity suitable for the 3D objects 106 to move freely.

The deformability of the deformable membrane 102 may be tuned/modified by changing the material of the deformable membrane 102, the material of the 3D objects 106, the material of the elastic medium, and/or the pressure within the cavity 104. By using a softer material (e.g., soft silicone), the deformable membrane 102 may be more easily deformed. Similarly, lowering the pressure within the cavity 104 may also cause the deformable membrane 102 to more easily deform. In some embodiments, the cavity 104 is inflated to a pressure of 0.20 psi to 0.30 psi. In some embodiments, the deformable membrane 102 features varying touch sensitivity due to varying spatial resolution and/or depth resolution. As used herein, spatial resolution may refer, for example, to how many pixels a deformation sensor has. The number of pixels may range from 1 (e.g., a sensor that simply detects contact with a target object) to thousands or millions (e.g., a dense tactile sensor provided by a time-of-flight sensor having thousands of pixels) or any suitable number.

Still referring to FIGS. 1 and 5, the optical sensor 105 may be a camera, a red green blue (RGB) sensor, RBG-depth (RGBD) sensor, a time-of-flight sensor, a proximity sensor. In some embodiments, the optical sensor 105 may be any device having an array of sensing devices (e.g., pixels) capable of detecting radiation in an ultraviolet wavelength band, a visible light wavelength band, or an infrared wavelength band. The optical sensor 105 may have any resolution. In some embodiments, the optical sensor 105 may be an omni-directional camera, or a panoramic camera. The optical sensor 105 may be any device capable of outputting a proximity signal indicative of a proximity of one of the 3D objects 106 to a neighboring 3D object 106. In some embodiments, the optical sensor 105 may include a laser scanner, a capacitive displacement sensor, a Doppler effect sensor, an eddy-current sensor, an ultrasonic sensor, a magnetic sensor, an internal sensor, a radar sensor, a LIDAR (Light Detection and Ranging) sensor, a sonar sensor, or the like.

The optical sensor 105 capable of sensing depth may be disposed within the cavity 104. The optical sensor 105 may have a field of view 132 directed through the 3D objects 106 and the medium, and toward an inner surface of the deformable membrane 102. In some embodiments, the field of view 132 of the optical sensor 105 may be 62°×45°+/−10%. As described in more detail below, the optical sensor 105 may be capable of detecting the positions and movements of the 3D objects 106. The optical sensor 105 may further be capable of detecting deflections of the deformable membrane 102 when the deformable membrane 102 comes into contact with an object. In one example, the optical sensor 105 is a time-of-flight sensor capable of measuring depth (i.e., a depth sensor). The time-of-flight sensor emits an optical signal (e.g., an infrared signal) and has individual detectors (i.e., “pixels”) that detect how long it takes for the reflected signal to return to the sensor. The time-of-flight sensor may have any desired resolution. The greater the number of pixels, the greater the resolution. The resolution of the sensor disposed within the optical sensor 105 may be changed. In some cases, low resolution (e.g., one “pixel” that simply detects displacement) may be desired. In others, a sensitive time-of-flight sensor may be used as a high-resolution optical sensor 105 that provides dense tactile sensing. Thus, the optical sensor 105 may be modular because the sensors may be changed depending on the application. A non-limiting example of a time-of-flight sensor is the Pico Flexx sold by PMD Technologies AG of Siegen, Germany. Other types of visual internal sensors include, by way of non-limiting example, stereo cameras, laser range sensors, structured light sensors/3D scanners, single cameras (such as with dots or other patterns inside), or any other suitable type of visual detector. For example, the optical sensor 105 may be configured as a stereo-camera capable of detecting deflections of the deformable membrane 102 by an object.

In some embodiments, the touch sensitivity of the deformation sensor assembly 100 may be determined as a function of the resolution of the internal sensors within the deformation sensor assembly 100. For example, the resolution of a deformation sensor assembly 100 may be increased due to an increase in the resolution of the optical sensor 105 and/or the quantity of optical sensors 105. For example, a decrease in the number of optical sensors 105 within a deformation sensor assembly 100 can be compensated for by a corresponding increase in the resolution of at least some of the remaining optical sensors 105. As discussed in more detail below, the aggregate deformation resolution may be measured as a function of the deformation resolution or touch sensitivity among the deformation sensor assemblies 100 in a portion of a robot. In some embodiments, aggregate deformation resolution may be based upon a quantity of deformable sensors and/or 3D objects in a portion of the robot and a deformation resolution obtained from each deformable sensor in that portion.

In some embodiments, the optical sensor 105 may include one or more internal pressure sensors (barometers, pressure sensors, etc., or any combination thereof) utilized to detect the general deformation of the deformable membrane 102 through the 3D objects 106 and/or the elastic medium in the cavity 104. In some embodiments, the optical sensor 105 may receive/send various data, such as through the conduit 512 (as shown in FIG. 6) discussed below, wireless data transmission (Wi-Fi, Bluetooth, etc.), or any other suitable data communication protocol. For example, pressure within the cavity 104 may be specified by a pressurization parameter and may be inversely proportional to the deformability of the deformable membrane 102 of the deformation sensor assembly 100. In some embodiments, the deformability of the deformable membrane 102 of the deformation sensor assembly 100 may be modified by changing pressure within the cavity 104 or a material of the deformable membrane 102 and/or the 3D objects 106. In some embodiments, receipt of an updated parameter value may result in a real-time or delayed update (pressurization, etc.).

Still referring to FIGS. 1 and 5, the light source 152 may be any device capable of outputting light, such as, but not limited to, a light-emitting diode, an incandescent light, a fluorescent light, or the like. The light source 152 may be attached to the bottom, top, side, or anywhere within the cavity 104 to illuminate the 3D objects 106. The light source 152 may emit lights that travel through the 3D objects 106 and/or the elastic medium in the cavity 104, and further be detected by the optical sensor 105. When the 3D objects 106 are colored, wavelengths of the emitted light may be altered by the 3D objects 106 based on the color of the 3D objects 106, and thus the detected light by the optical sensor 105 regarding the positions, color profiles, and/or orientations of the 3D objects 106 may reflect the color distribution of the 3D objects 106 simultaneously with the movements of the 3D objects 106 and/or with the deformation/displacement of the deformable membrane 102. In some embodiments, when the light source 152 is included in deformation sensor assembly 100, the deformable membrane 102 and/or the bottom surface 103 may be opaque to external lights such that the detected light by the optical sensor 105 is based on the emitted light of the light source 152.

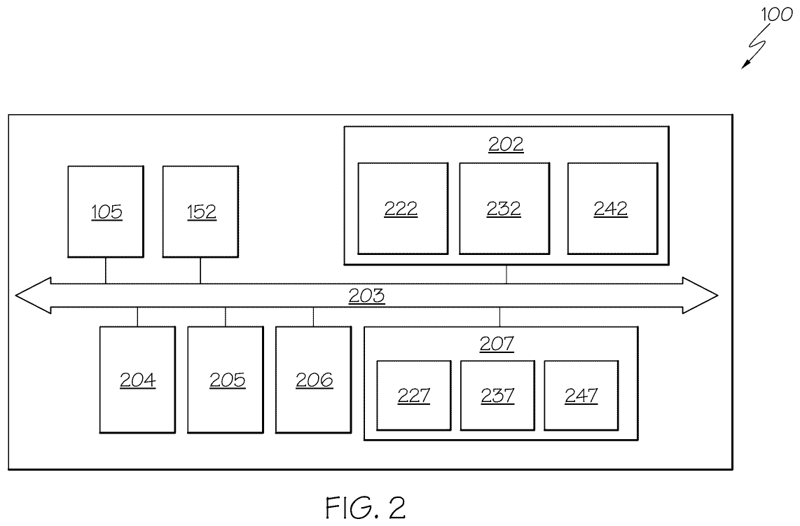

In operation, the optical sensor 105 may capture the positions and color profiles of the 3D objects 106 in their original positions when the deformable membrane 102 is not deformable due to external force 112. The optical sensor 105 may continue to monitor the color distributions of the 3D objects 106. The color distributions of the 3D objects 106 may correlate with the nature and extent of deformation of the deformable membrane 102. The deformation sensor assembly 100 may include a computing device (such as illustrated in FIG. 2) that includes one or more logics, such as operating logic 222, sensor logic 232 for receiving image data from one or more optical sensors 105, detection logic 242 for determination of the deformation of the deformable membrane 102 and the positions, the color profiles, and/or the orientations of the 3D objects 106. In operation, as illustrated in FIG. 5, in some embodiments, when the deformable membrane 102 comes into direct contact with an external object, the deformable membrane 102 may deform due to the external force 112 from manipulating the external object and affects the configuration of the cavity 104. The 3D objects 106 within the cavity 104 may move and reoriented according to the shape and volume changes of the deformable membrane 102. The optical sensor 105 controlled by the sensor logic 232 may capture the real-time images of the 3D objects 106, in terms of their positions, shapes, color profiles of each 3D object, and color distribution, when more than one 3D objects 106 are provided. The detection logic 242 may apply one or more models for object manipulation based on the data captured by the optical sensor 105, data captured by other sensors of the deformation sensor assembly 100, historical 3D object position data 227, historical 3D object color distribution data 237, or a combination thereof.

The detection logic 242 of the deformation sensor assembly 100 may include deformable surface modeling. The deformation surface modeling may be based on Finite Element Model (FEM) or Mass-Spring Model. Deformation sensor assembly 100 may simulate the deformable membrane 102 using FEM to determine how it deforms under various external forces 112 based on modeling of material properties of the deformable membrane 102, such as elasticity and stiffness. Deformation sensor assembly 100 may use the mass-spring model to represent the deformable surface by representing each mass as a representing point on the surface and further including springs connecting these points to model elastic behavior.

The detection logic 242 of the deformation sensor assembly 100 may include a 3D object dynamics modeling. The deformation sensor assembly 100 may model the color distribution and the movement of the 3D objects 106 using physics-based simulations and particle system modeling. As the deformable membrane 102 deforms, the 3D objects 106 move and reorient accordingly. The dynamics of the 3D objects 106 (position, color profile shifting) can be calculated based on the deformable membrane's 102 and/or cavity's 104 changing shape. The particle system modeling may use forces (such as gravity, contact forces, and friction) to determine the motion of each 3D object 106. The detection logic 242 may include visual and sensory feedback modeling. The visual and sensory feedback modeling may be used to calibrate the optical sensor 105 to capture the position and the color distribution of the 3D objects 106 and further track each 3D object's position, movement, colors, and/or orientation.

In some embodiments, the various logics, such as the operating logic 222, the sensor logic 232, and the detection logic 242, may include one or more machine learning models, such as one or more neural networks. For example, a machine learning model may be included and trained to correlate the visual patterns observed (positions and color distributions of the 3D objects 106) with specific deformations of the deformable membrane 102. The training may be based on a dataset of known deformations and corresponding 3D object configurations. The one or more machine learning models may continue to be trained with the inputs of the optical sensor 105 and/or other sensors in deformation sensor assembly 100.

Referring now to FIG. 2, components of an example deformation sensor assembly 100 described herein are schematically illustrated. The deformation sensor assembly 100 may include a computing device in some embodiments, and the computing device may be shared with or implanted in a robot (i.e., the robot includes the hardware and software for performing the deformation sensing and manipulation functions described herein).

The example deformation sensor assembly 100 provides a system for sensing deformation information of the deformation sensor assembly 100, and/or a non-transitory computer usable medium having computer readable program code for performing the deformation sensing and manipulation functions embodied as hardware, software, and/or firmware, according to embodiments shown and described herein. While in some embodiments, the computing device of the deformation sensor assembly 100 may be configured as a general-purpose computer with the requisite hardware, software, and/or firmware, in some embodiments, the computing device of the deformation sensor assembly 100 may be configured as a mobile phone, a robot, a vehicle, an electric appliance, and the like. It should be understood that the software, hardware, and/or firmware components depicted in FIG. 2 may also be provided in other computing devices external to the deformation sensor assembly 100 (e.g., data storage devices, remote server computing devices, and the like).

As also illustrated in FIG. 2, the deformation sensor assembly 100 (or other additional computing devices) may include the optical sensor 105 for generating image data of the 3D objects 106 within the bubble module 101 of the deformation sensor assembly 100, a light source 152 within the bubble module 101, a processor 204, input/output hardware 205, network interface hardware 206, a data storage component 207 (which may include historical 3D object position data 227, historical 3D object color distribution data 237, and any other data 247 for performing the functionalities described herein), and a non-transitory memory component 202. The memory component 202 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 202 may be configured to store operating logic 222, sensor logic 232 for receiving image data from one or more optical sensors 105, detection logic 242 for detecting a type of object and/or detecting a pose of an object based on historical 3D object position data 227 and historical 3D object color distribution data 237 (each of which may be embodied as computer readable program code, firmware, or hardware, as an example). A local interface 203 is also included in FIG. 2 and may be implemented as a bus or other interface to facilitate communication among the components of the deformation sensor assembly 100.

The processor 204 may include any processing component configured to receive and execute computer-readable code instructions (such as from the data storage component 207 and/or memory component 202). The input/output hardware 205 may include an electronic display, keyboard, mouse, printer, camera, microphone, speaker, touch-screen, and/or other device for receiving, sending, and/or presenting data. The network interface hardware 206 may include any wired or wireless networking hardware, such as a modem, LAN port, wireless fidelity (Wi-Fi) card, WiMax card, mobile communications hardware, and/or other hardware for communicating with other networks and/or devices, such as to receive the data from various sources, for example.

It should be understood that the data storage component 207 may reside local to and/or remote from the deformation sensor assembly 100, and may be configured to store one or more pieces of data for access by the deformation sensor assembly 100 and/or other components. As illustrated in FIG. 2, the data storage component 207 may include the historical 3D object position data 227 and the historical 3D object color distribution data 237, which in at least one embodiment includes image data generated by one or more optical sensors 105. The historical 3D object position data 227 and the historical 3D object color distribution data 237 may be stored in one or more data storage devices. Historical 3D object color distribution data 237 may include, but is not limited to, historical color, shape, deformation, and other relevant physical and chemical properties of the 3D objects 106. Other data 247 used to perform the functionalities described herein may also be stored in the data storage component 207. In some embodiments, the deformation sensor assembly 100 may be coupled to a remote server or other data storage device that stores the relevant data.

Included in the memory component 202 may be the operating logic 222, the sensor logic 232, and the detection logic 242. The operating logic 222 may include an operating system and/or other software for managing components of the deformation sensor assembly 100. The sensor logic 232 may reside in the memory component 202 and may be configured to receive and store image data from one or more optical sensors 105. The detection logic 242 may be configured to use data from a deformable sensor and/or one or more external image sensors to detect a type of object and/or a pose of an object. The operating logic 222, the sensor logic 232, and the detection logic 242 may be trained and provide machine learning capabilities via a neural network as described herein. By way of example, and not as a limitation, the neural network may utilize one or more artificial neural networks (ANNs). ANNs may include node inputs, one or more hidden activation layers, and node outputs, and may be utilized with activation functions in the one or more hidden activation layers. ANNs are trained by applying such activation functions to training data sets to determine an optimized solution from adjustable weights and biases applied to nodes within the hidden activation layers to generate one or more outputs as the optimized solution with a minimized error. Further, each of the various modules may include a generative artificial intelligence (AI) algorithm. The generative AI algorithm may include a general adversarial network (GAN) that has two or more networks including one or more generator neural networks and one or more discriminator neural networks. The generative AI algorithm may also be based on variation autoencoder (VAE) models or transformer-based models.

The light source 152 is coupled to the local interface 203 and communicatively coupled to the processor 204. The light source 152 may be any device capable of outputting light, such as, but not limited to, a light emitting diode, an incandescent light, a fluorescent light, or the like. The optical sensor 105 is coupled to the local interface 203 and communicatively coupled to the processor 204. The optical sensor 105 may be a camera, a RGB sensor, a RGBD sensor, a time-of-flight sensor, or a proximity sensor.

The components illustrated in FIG. 2 are merely example and are not intended to limit the scope of this disclosure. More specifically, while the components in FIG. 2 are illustrated as residing within the deformation sensor assembly 100, this is a non-limiting example. In some embodiments, one or more of the components may reside external to the deformation sensor assembly 100.

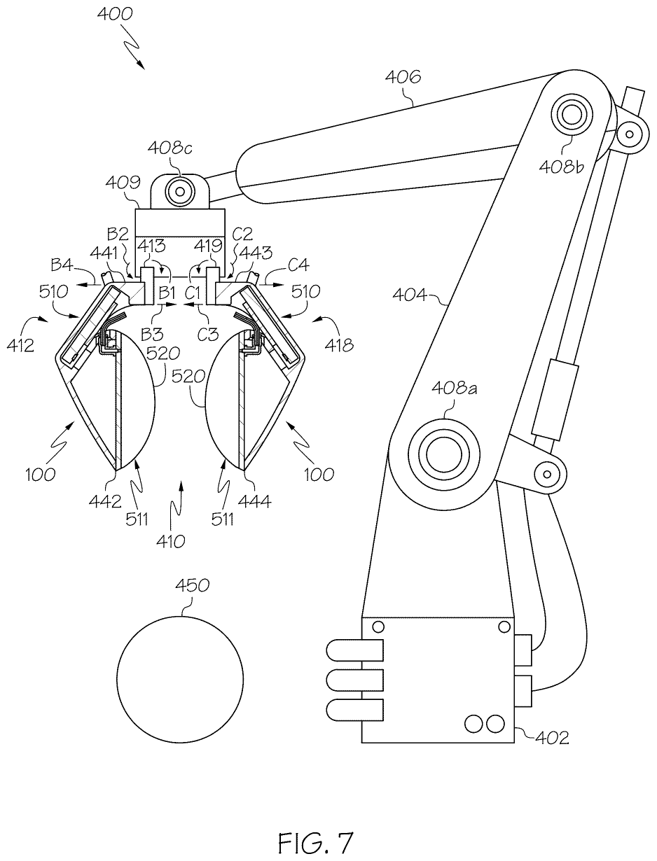

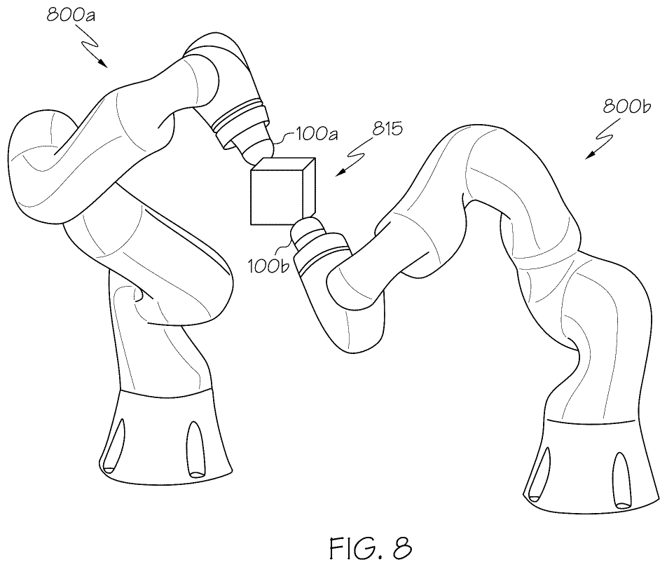

Referring now to FIG. 6, the deformation sensor assembly 100 including components configured to couple the deformation sensor assembly 100 with external devices or components is schematically illustrated. The deformation sensor assembly 100 is shown in its assembled form. The deformation sensor assembly 100 may include the bubble module 101 including the deformable membrane 102, the bottom surface 103, and a ring 524 for securing the bubble module 101 to an external device or component, such as a robot end effector or a robot as illustrated in FIG. 7. The deformation sensor assembly 100 may be removably coupled to the external device or component using any suitable means, such as threaded inserts 525 for securing the bottom surface 103 to the external device.

More particularly, the bottom surface 103 may include an external surface 522A. The bottom surface 103 may be formed from a transparent material, such as an acrylic so that a field of view of an external internal sensor can extend into the cavity 104 and is not obstructed by the bottom surface 103. The ring 524 may be positioned around the bottom surface 103, thereby encircling the bottom surface 103 to sandwich the deformable membrane 102 between the bottom surface 103 and the ring 524. As noted above, the threaded inserts 525 may be used to further secure the bubble module 101 to any external device by positioning an outer edge of the bottom surface 103 along the external surface 522A of the bottom surface 103 and inserting the threaded inserts 525 through threaded holes on an outer surface of the external device.

In some embodiments, the bottom surface 103 may include one or more conduits 512. The conduit 512 may include a tube 512A and a tube fitting 512B coupled to the bottom surface. The conduit 512 may further include a valve or any other suitable mechanism. The tube fitting 512B is shown attached to the bottom surface 103 at an orifice (not shown) and the tube 512A extends from the tube fitting 512B to deliver the elastic medium or the 3D objects 106 into the cavity 104 of the bubble module 101. The conduit 512 may be utilized to fill or empty the cavity 104 of the bubble module 101. The conduit 512 may be further utilized to provide power and/or data/signals, such as to the optical sensor 105 and the light source 152 by way of a conduit, such as for USB (universal serial bus) or any other suitable type of power and/or signal/data connection. As used herein, an airtight conduit may include any type of passageway through which air or any other fluid (such as liquid) cannot pass. In this example, an airtight conduit may provide a passageway through which solid objects (such as wires/cables) may pass through with an airtight seal being formed around such wires/cables at each end of the airtight conduit. Other embodiments utilized wireless optical sensors 105 to transmit and/or receive data and/or power. In various embodiments where the elastic medium is not a gas, such as silicone, the cavity 104 and/or conduit 512 may not necessarily be airtight.

Referring now to FIG. 7, an example robot 400 is depicted. The robot 400 may generally include a base 402 coupled to one or more arm segments, such as a first arm segment 404 and a second arm segment 406 via one or more joints 408a, 408b, 408c, and an end effector 410 including a first finger 412 and a second finger 418 for manipulating a target object 450. The first finger 412 and the second finger 418 of the end effector 410 of the robot 400 each include an example deformation sensor assembly 100. The deformation sensor assembly 100 may be directly connected or coupled to a coupling member 409.

The first finger 412 may include a proximal end 441 and a distal end 442. In some embodiments, a grip mechanism 413 causes the first finger 412 to pivot with respect to the end effector 410 and the distal end 442 to move outwardly in the direction of arrow B1 away from the second finger 418 when the end effector 410 is moved toward the open position and inwardly in the direction of arrow B2 toward the second finger 418 when the end effector 410 is moved toward the closed position. In addition, the second finger 418 may include a proximal end 443 and a distal end 444. In some embodiments, a grip mechanism 419 causes the second finger 418 to pivot with respect to the end effector 410 and the distal end 444 to move outwardly in the direction of arrow C1 away from the first finger 412 when the end effector 410 is moved toward the open position and inwardly in the direction of arrow C2 toward the first finger 412 when the end effector 410 is moved toward the closed position. In this embodiment, the grip mechanisms 413, 419 may be any suitable translating member such as, for example, an actuator, rotary motor, or the like.

In some embodiments, the grip mechanism 413 of the first finger 412 and the grip mechanism 419 of the second finger 418 operate to linearly translate the first finger 412 and the second finger 418 relative to the end effector 410 instead of pivoting, as discussed above. As such, the grip mechanism 413 causes the first finger 412 to move inwardly in the direction of arrow B3 toward the second finger 418 when the end effector 410 is moved toward the closed position and outwardly in the direction of arrow B4 away from the second finger 418 when the end effector 410 is moved toward the open position. In addition, the grip mechanism 419 causes the second finger 418 to move inwardly in the direction of arrow C3 toward the first finger 412 when the end effector 410 is moved toward the closed position and outwardly in the direction of arrow C4 away from the first finger 412 when the end effector 410 is moved toward the open position. In this embodiment, the grip mechanisms 413, 419 may be any suitable translating member such as, for example, a linear actuator, a rack and pinion gear, or the like. The robot 400 may further include any combination of the components illustrated in FIG. 2 and operate in the manner discussed herein.

In operation, in some embodiments, the robot 400 may include a closed-loop feedback control model. The robot 400 and deformation sensor assembly 100 may feed the real-time data from the optical sensor 105 into a feedback control system that adjusts the manipulation forces applied by the robot 400. For example, if the object being manipulated starts to slip or deform undesirably, the feedback loop would detect this (via changes in the body movements) and adjust the robot's grip or motion accordingly. The robot 400 may deploy a model predictive control (MPC). The MPC may use the model of the deformation sensor assembly 100 (e.g., a surface deformation and object dynamics models) to predict future states based on current inputs. By forecasting the floor sensor's 105 response to different manipulation forces, the control system of the robot 400 can optimize its actions to achieve the desired manipulation outcome while maintaining the integrity of both the sensor and the object. The robot 400 may further use reinforcement learning (RL) for adaptive manipulation applications. The RL-based approach may enable the robot to learn how to manipulate various objects by trial and error. The learning agent uses the visual feedback from the optical sensor 105 (body positions and movements) to adjust the actions of the robot 400, gradually learning the optimal manipulation strategies for different types of objects.

FIG. 8 schematically depicts an example non-limiting first robot 800a having a first deformation sensor assembly 100a and an example second robot 800b having a second deformation sensor assembly 100b. In this illustrated example, the first robot 800a and the second robot 800b may cooperate for dual-arm manipulation wherein both the first deformation sensor assembly 100a and the second deformation sensor assembly 100b contact an object 815. As stated above, the deformation sensor assemblies 100 (depicted here as 100a and 100b) described herein may be used as an end effector of a robot to manipulate an object. The first and second deformation sensor assemblies 100a, 100b may allow the robots to handle the object 815 which is fragile due to the flexible nature of the deformable membrane. Further, the first and second deformation sensor assemblies 100a, 100b may be useful for robot-to-human contact because in some embodiments the deformable membrane may be softer and/or more flexible/deformable, rather than rigid (non-deformable or nearly so) to the touch.

In addition to geometry and pose estimation, the first deformation sensor assembly 100a may be used to determine how much force a robot 800a (or other device) is exerting on the object 815. Although reference is made to first robot 800a, any such references may in some embodiments utilize second robot 800b, any other suitable devices, and/or any combinations thereof. This information may be used by the robot 800a to more accurately grasp objects 815. For example, the displacement of the deformable membrane 102 may be modeled. A model of the displacement of the deformable membrane 102 may be used to determine how much force is being applied to the object 815. The determined force as measured by the displacement of the deformable membrane 102 may then be used to control a robot 800a to more accurately grasp objects 815. As an example, the amount of force a robot 800a (discussed in more detail below) applies to a fragile object 815 may be of importance so that the robot 800a does not break the object 815 that is fragile. In some embodiments, the object 815 may be assigned a softness value (or fragility value), where the robot 800a may programmed to interact with all objects 815 based upon the softness value (which may be received at a processor, for example, from a database, server, user input, etc.).

In some embodiments, an open-loop control system for a deformation sensor assembly 100a or a robot 800a may include a user interface to specify any suitable value (e.g., stiffness of the deformation sensor assembly 100 based upon rotation of the wheel, raising/lowering the wheel, air stiffness, membrane stiffness, softness value pertaining to an object 815, etc.) for initialization and/or updating (such as on a display device). In some closed-loop embodiments, a robot 800a and/or floor sensors may be able to identify specific objects 815 (such as via object recognition in a vision system, etc.) whereby the object softness value may be modified, which may lead to automatic modification of the overall stiffness of a deformable sensor (such as rotating a wheel to a different radial portion having a different stiffness value and/or raising/lowering the wheel via the support member) or utilizing a different deformation sensor assembly 100b having a more suitable stiffness or range of stiffness values, deformability aggregate spatial resolution, depth resolution, pressure, and/or material for the deformable membrane 102. In some embodiments, a processor in a deformation sensor assembly 100a and/or a robot 800a may receive data from the optical sensor 105 representing the contact region. In various embodiments, a processor in a deformation sensor assembly 100a and/or a robot 800a may determine a vector normal to a surface of the object based on the data representing the contact region and utilize the vector to determine which direction the object is oriented.

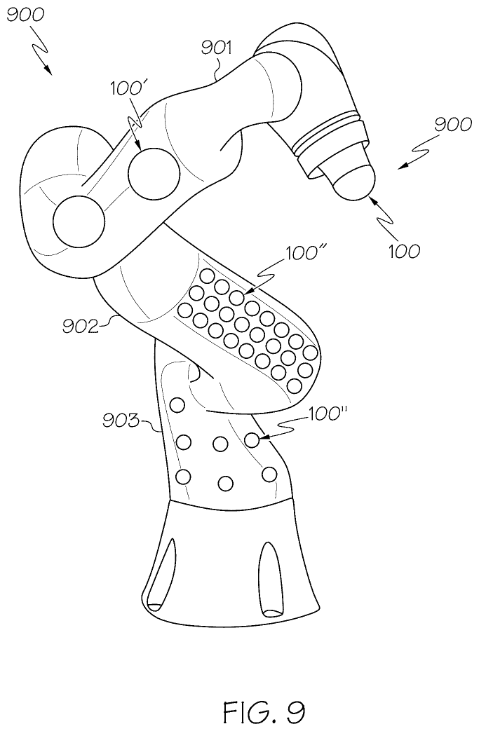

FIG. 9 schematically depicts an example non-limiting robot 900 with a plurality of deformable sensors provided at various locations on the robot 900. The robot 900 may include one or more robot arms. In some embodiments, the robot 900 may have a plurality of deformation sensor assemblies 100, 100′ and 100″ at different locations. In some embodiments, a deformation sensor assembly 100 may have a clamp or other suitable attachment mechanism. For example, the deformation sensor assembly 100 may be removably attached to a robot 900, and/or a robot 900 which may have features to provide for attachment and/or removal of a deformation sensor assembly 100. Any suitable type of clamp, fastener, or attachment mechanism may be utilized in some embodiments. Each deformation sensor assembly 100 may have a desired spatial resolution and/or a desired depth resolution depending on its location on the robot 900. As shown in FIG. 9, deformation sensor assemblies 100 may be of any suitable size, which may vary even within an arm portion of the robot 900. For example, one or more deformation sensor assemblies 100 may be located at different portions of the robot 900, such as portions 901, 902, and 903. Although arm portions 901, 902, 903 are depicted as being discrete/non-overlapping, overlap may occur in other embodiments.

In the illustrated embodiment, a deformation sensor assembly 100 may act as an end effector of the robot 900, and have a high spatial resolution and/or depth resolution. One or more deformation sensor assemblies 100′ are disposed on a first arm portion 901 and a second arm portion 902 (the terms “arm portion” and “portion” being used interchangeably throughout). An arm portion may have one or more deformation sensor assemblies 100, or none at all. The deformation sensor assemblies 100′ may be shaped to conform to the shape of the first arm portion 901 and/or the second arm portion 902. It may be noted that the deformation sensor assemblies 100 described herein may take on any shape depending on the application. Deformation sensor assemblies 100′ may be very flexible and thus deformable. This may be beneficial in human-robot interactions. In this way, the robot 900 may contact a person (e.g., to give the person a “hug”) without causing harm due to the softness of the deformation sensor assemblies 100′ and/or due to an ability to control the force of the contact with an object. The spatial resolution of one or more deformation sensor assembly 100′ in the arm portions 901, 902 may be high or low depending on the application.

In the example of FIG. 9, the deformation sensor assemblies 100″ near the base portion 903 of the robot 900 may have a low spatial resolution, and may be configured to only detect contact with a target object. The deformability of deformation sensor assemblies 100″ near the base of the robot 900 may be set based on the application of the robot 900. For example, the wheel within a deformation sensor assembly 100 may have radial portions using radial portions with materials/stiffness that are better suited to particular applications (such as placement location on a robot 900). The depth resolution and/or spatial resolution of the deformation sensor assemblies 100 may be varied along different parts of the robot 900. For example, one portion 903 it may not be necessary to identify the shape and/or pose of an object coming into contact with a particular deformation sensor assembly 100, as simply registering contact with an object may provide sufficient information, whereas contact with another portion (such as 901) may produce pose and/or shape information derived from the contact.

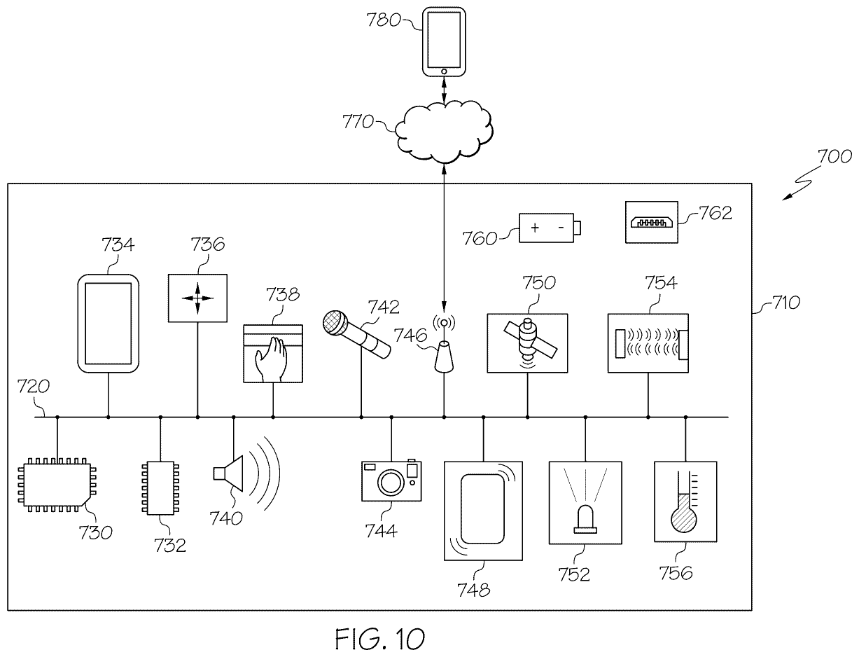

Turning now to FIG. 10, example components of one non-limiting embodiment of a robot 700 is schematically depicted. The robot 700 includes a bubble module 710, a communication path 720, a processor 730, a memory module 732, a display 734, an inertial measurement unit 736, an input device 738, an audio output device 740 (e.g., a speaker), a microphone 742, an image sensor 744, network interface hardware 746, a tactile feedback device 748, a location sensor 750, a light 752, a proximity sensor 754, a temperature sensor 756, a battery 760, and a charging port 762. The components of the robot 700 other than the bubble module 710 may be contained within or mounted to the bubble module 710. The various components of the robot 700 and the interaction thereof will be described in detail below. It should be understood that robots of the present disclosure may include more or fewer components than illustrated by FIG. 10.

The communication path 720 may be formed from any medium that is capable of transmitting a signal such as, for example, conductive wires, conductive traces, optical waveguides, or the like. Moreover, the communication path 720 may be formed from a combination of mediums capable of transmitting signals. In one embodiment, the communication path 720 comprises a combination of conductive traces, conductive wires, connectors, and buses that cooperate to permit the transmission of electrical data signals to components such as processors, memories, sensors, input devices, output devices, and communication devices. Accordingly, the communication path 720 may comprise a bus. Additionally, it is noted that the term “signal” means a waveform (e.g., electrical, optical, magnetic, mechanical, or electromagnetic), such as DC, AC, sinusoidal wave, triangular wave, square wave, vibration, and the like, capable of traveling through a medium. The communication path 720 communicatively couples the various components of the robot 700. As used herein, the term “communicatively coupled” means that coupled components are capable of exchanging data signals with one another such as, for example, electrical signals via a conductive medium, electromagnetic signals via air, optical signals via optical waveguides, and the like.

The processor 730 of the robot 700 may be any device capable of executing machine-readable instructions. Accordingly, the processor 730 may be a controller, an integrated circuit, a microchip, a computer, or any other computing device. The processor 730 may be communicatively coupled to the other components of the robot 700 by the communication path 720. This may, in various embodiments, allow the processor 730 to receive data from the one or more deformation sensor assemblies 100 which may be part of the robot 700. In other embodiments, the processor 730 may receive data directly from one or more optical sensors 105 which are part of one or more deformation sensor assemblies 100 on a robot 700. Accordingly, the communication path 720 may communicatively couple any number of processors with one another, and allow the components coupled to the communication path 720 to operate in a distributed computing environment. Specifically, each of the components may operate as a node that may send and/or receive data. While the embodiment depicted in FIG. 10 includes a single processor 730, other embodiments may include more than one processor.

Still referring to FIG. 10, the memory module 732 of the robot 700 is coupled to the communication path 720 and communicatively coupled to the processor 730. The memory module 732 may, for example, contain instructions to detect a shape of an object that has deformed the deformable membrane 102 of a deformation sensor assembly 100. In this example, these instructions stored in the memory module 732, when executed by the processor 730, may allow for the determination of the shape of an object based on the positions of the 3D objects 106, the deformation of the deformable membrane 102. The memory module 732 may comprise RAM, ROM, flash memories, hard drives, or any non-transitory memory device capable of storing machine-readable instructions such that the machine-readable instructions can be accessed and executed by the processor 730. The machine-readable instructions may comprise one or more logic or algorithms written in any programming language of any generation such as, for example, machine language that may be directly executed by the processor, or assembly language, object-oriented programming (OOP), scripting languages, microcode, etc., that may be compiled or assembled into machine-readable instructions and stored in the memory module 732. Alternatively, the machine-readable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the embodiment depicted in FIG. 10 includes a single memory module 732, other embodiments may include more than one memory module.

The display 734, if provided, is coupled to the communication path 720 and communicatively coupled to the processor 730. The display 734 may be any device capable of providing tactile output in the form of refreshable tactile messages. A tactile message conveys information to a user by touch. A tactile message may also be in the form of any shape, such as the shape of an object manipulated by the robot 700 or contact with. The display 734 may provide information to the user regarding the operational state of the robot 700.

The inertial measurement unit 736, if provided, is coupled to the communication path 720 and communicatively coupled to the processor 730. The inertial measurement unit 736 may include one or more accelerometers and one or more gyroscopes. The inertial measurement unit 736 transforms the sensed physical movement of the robot 700 into a signal indicative of an orientation, a rotation, a velocity, or an acceleration of the robot 700. The operation of the robot 700 may depend on an orientation of the robot 700 (e.g., whether the robot 700 is horizontal, tilted, and the like). Some embodiments of the robot 700 may not include the inertial measurement unit 736, such as embodiments that include an accelerometer but not a gyroscope, embodiments that include a gyroscope but not an accelerometer, or embodiments that include neither an accelerometer nor a gyroscope.

Still referring to FIG. 10, one or more input devices 738 are coupled to the communication path 720 and communicatively coupled to the processor 730. The input device 738 may be any device capable of transforming user contact into a data signal that can be transmitted over the communication path 720 such as, for example, a button, a switch, a knob, a microphone, or the like. In various embodiments, an input device 738 may be a deformation sensor assembly 100 and/or a optical sensor 105 as described above. In some embodiments, the input device 738 includes a power button, a volume button, an activation button, a scroll button, or the like. The one or more input devices 738 may be provided so that the user may interact with the robot 700, such as to navigate menus, make selections, set preferences, and other functionality described herein. In some embodiments, the input device 738 includes a pressure sensor, a touch-sensitive region, a pressure strip, or the like. It should be understood that some embodiments may not include the input device 738. As described in more detail below, embodiments of the robot 700 may include multiple input devices disposed on any surface of the bubble module 710. In some embodiments, one or more of the input devices 738 are configured as a fingerprint sensor for unlocking the robot 700. For example, only a user with a registered fingerprint may unlock and use the robot 700.

The speaker 740 (i.e., an audio output device) is coupled to the communication path 720 and communicatively coupled to the processor 730. The speaker 740 transforms audio message data from the processor 730 of the robot 700 into mechanical vibrations producing sound. For example, the speaker 740 may provide the user navigational menu information, setting information, status information, information regarding the environment as detected by image data from the one or more image sensors 744, and the like. However, it should be understood that, in other embodiments, the robot 700 may not include the speaker 740.

The microphone 742 is coupled to the communication path 720 and communicatively coupled to the processor 730. The microphone 742 may be any device capable of transforming a mechanical vibration associated with sound into an electrical signal indicative of the sound. The microphone 742 may be used as an input device 738 to perform tasks, such as navigate menus, input settings and parameters, and any other tasks. It should be understood that some embodiments may not include the microphone 742.

Still referring to FIG. 10, the image sensor 744 is coupled to the communication path 720 and communicatively coupled to the processor 730. The image sensor 744 may be any device having an array of sensing devices (e.g., pixels) capable of detecting radiation in an ultraviolet wavelength band, a visible light wavelength band, or an infrared wavelength band. The image sensor 744 may have any resolution. The image sensor 744 may be an omni-directional camera, or a panoramic camera. In some embodiments, one or more optical components, such as a mirror, fish-eye lens, or any other type of lens may be optically coupled to the image sensor 744.

The network interface hardware 746 is coupled to the communication path 720 and communicatively coupled to the processor 730. The network interface hardware 746 may be any device capable of transmitting and/or receiving data via a network 770. Accordingly, network interface hardware 746 can include a wireless communication module configured as a communication transceiver for sending and/or receiving any wired or wireless communication. For example, the network interface hardware 746 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, network interface hardware 746 includes hardware configured to operate in accordance with the Bluetooth wireless communication protocol. In another embodiment, network interface hardware 746 may include a Bluetooth send/receive module for sending and receiving Bluetooth communications to/from a portable electronic device 780. The network interface hardware 746 may also include a radio frequency identification (“RFID”) reader configured to interrogate and read RFID tags.

In some embodiments, the robot 700 may be communicatively coupled to a portable electronic device 780 via the network 770. In some embodiments, the network 770 is a personal area network that utilizes Bluetooth technology to communicatively couple the robot 700 and the portable electronic device 780. In other embodiments, the network 770 may include one or more computer networks (e.g., a personal area network, a local area network, or a wide area network), cellular networks, satellite networks and/or a global positioning system and combinations thereof. Accordingly, the robot 700 can be communicatively coupled to the network 770 via wires, via a wide area network, via a local area network, via a personal area network, via a cellular network, via a satellite network, or the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near-field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

Still referring to FIG. 10, as stated above, the network 770 may be utilized to communicatively couple the robot 700 with the portable electronic device 780. The portable electronic device 780 may include a mobile phone, a smartphone, a personal digital assistant, a camera, a dedicated mobile media player, a mobile personal computer, a laptop computer, and/or any other portable electronic device capable of being communicatively coupled with the robot 700. The portable electronic device 780 may include one or more processors and one or more memories. The one or more processors can execute logic to communicate with the robot 700. The portable electronic device 780 may be configured with wired and/or wireless communication functionality for communicating with the robot 700. In some embodiments, the portable electronic device 780 may perform one or more elements of the functionality described herein, such as in embodiments in which the functionality described herein is distributed between the robot 700 and the portable electronic device 780.

The tactile feedback device 748 is coupled to the communication path 720 and communicatively coupled to the processor 730. The tactile feedback device 748 may be any device capable of providing tactile feedback to a user. The tactile feedback device 748 may include a vibration device (such as in embodiments in which tactile feedback is delivered through vibration), an air-blowing device (such as in embodiments in which tactile feedback is delivered through a puff of air), or a pressure generating device (such as in embodiments in which the tactile feedback is delivered through generated pressure). It should be understood that some embodiments may not include the tactile feedback device 748.

The location sensor 750 is coupled to the communication path 720 and communicatively coupled to the processor 730. The location sensor 750 may be any device capable of generating an output indicative of a location. In some embodiments, the location sensor 750 includes a global positioning system (GPS) sensor, though embodiments are not limited thereto. Some embodiments may not include the location sensor 750, such as embodiments in which the robot 700 does not determine a location of the robot 700 or embodiments in which the location is determined in other ways (e.g., based on information received from the image sensor 744, the microphone 742, the network interface hardware 746, the proximity sensor 754, the inertial measurement unit 736 or the like). The location sensor 750 may also be configured as a wireless signal sensor capable of triangulating a location of the robot 700 and the user by way of wireless signals received from one or more wireless signal antennas.

Still referring to FIG. 10, the light 752 is coupled to the communication path 720 and communicatively coupled to the processor 730. The light 752 may be any device capable of outputting light, such as, but not limited to, a light-emitting diode, an incandescent light, a fluorescent light, or the like. Some embodiments include a power indicator light that is illuminated when the robot 700 is powered on. Some embodiments include an activity indicator light that is illuminated when the robot 700 is active or processing data. Some embodiments include an illumination light for illuminating the environment in which the robot 700 is located. Some embodiments may not include the light 752.

The proximity sensor 754 is coupled to the communication path 720 and communicatively coupled to the processor 730. The proximity sensor 754 may be any device capable of outputting a proximity signal indicative of a proximity of the robot 700 to another object. In some embodiments, the proximity sensor 754 may include a laser scanner, a capacitive displacement sensor, a Doppler effect sensor, an eddy-current sensor, an ultrasonic sensor, a magnetic sensor, an internal sensor, a radar sensor, a lidar sensor, a sonar sensor, or the like. Some embodiments may not include the proximity sensor 754, such as embodiments in which the proximity of the robot 700 to an object is determined from inputs provided by other sensors (e.g., the image sensor 744, the speaker 740, etc.) or embodiments that do not determine a proximity of the robot 700 to an object.

The temperature sensor 756 is coupled to the communication path 720 and communicatively coupled to the processor 730. The temperature sensor 756 may be any device capable of outputting a temperature signal indicative of a temperature sensed by the temperature sensor 756. In some embodiments, the temperature sensor 756 may include a thermocouple, a resistive temperature device, an infrared sensor, a bimetallic device, a change of state sensor, a thermometer, a silicon diode sensor, or the like. Some embodiments of the robot 700 may not include the temperature sensor 756.

Still referring to FIG. 10, the robot 700 is powered by the battery 760, which is electrically coupled to the various electrical components of the robot 700. The battery 760 may be any device capable of storing electric energy for later use by the robot 700. In some embodiments, the battery 760 is a rechargeable battery, such as a lithium-ion battery or a nickel-cadmium battery. In embodiments in which the battery 760 is a rechargeable battery, the robot 700 may include the charging port 762, which may be used to charge the battery 760. Some embodiments may not include the battery 760, such as embodiments in which the robot 700 is powered the electrical grid, by solar energy, or by energy harvested from the environment. Some embodiments may not include the charging port 762, such as embodiments in which the apparatus utilizes disposable batteries for power.

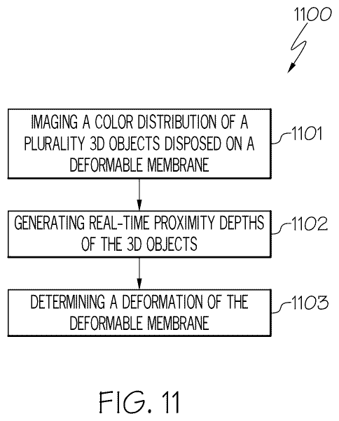

Turning now to FIG. 11, a flowchart illustrates an example method 1100 for determining the deformation based on the deformation sensor assembly 100 as described herein. At block 1101, the method 1100 may include imaging, using the optical sensor 105, a color distribution of the plurality of 3D objects 106 disposed on a deformable membrane 102. Each 3D object 106 includes two or more colored parts 116. The colored parts 116 include two or more colors. At least one pair of neighbor colored parts 116 includes different colors. The color distribution includes one or more captured colors for each 3D object 106. At block 1102, the method 1100 may include generating real-time proximity depths of the 3D objects 106 based on the color distribution of the 3D objects 106. At block 1103, the method 1100 may include determining a deformation of the deformable membrane 102 at least partially based on the real-time proximity depths and historical proximity depths of the 3D objects 106.

In some embodiments, the one or more captured colors of a corresponding 3D object 106 may depend on an orientation angle between the optical sensor 105 and the corresponding 3D object 106. The one or more captured colors of a corresponding 3D object 106 may be a subgroup of the colors of the corresponding 3D object 106.

In some embodiments, each 3D object may include a base part and an optical part 126. The base part may include the two or more colored parts 116. The optical part may be configured to cause an angle-dependent color viewing based on reflection, refraction, diffraction, or a combination thereof. The optical part 126 may include a concave shape, a convex shape, a pyramid shape, a dome shape, or a faceted shape.

In some embodiments, the 3D objects 106 may have 3D shapes. The 3D shapes may include a polyhedron shape, a tetrahedron shape, a polygonal base pyramid shape, or a combination thereof, and each colored part is a facet of the 3D shape.

In some embodiments, the 3D objects 106 may be disposed within a medium. The medium may include air, latex, silicone, acrylic, plastics, polycarbonate, opaque plastics with embedded particles, ceramics, or a combination thereof. The deformable membrane 102 may be coupled to a bottom surface 103. The bottom surface 103 and the deformable membrane 102 may defines a cavity 104 therein. The 3D objects 106 may be disposed within the cavity 104.

In some embodiments, the 3D objects 106 and the deformable membrane 102 may be mechanically coupled to a robot 400. The robot 400 may include one or more robotic arms.

It should now be understood that embodiments of the present disclosure are directed to deformable sensors, deformation sensor assemblies, and robots including deformation sensors capable of detecting contact with a target object as well as determining the geometric shape and pose of the target object. The information provided by the deformation sensors may be used to control the interaction of the robot with the target object. The depth resolution and spatial resolution of the deformation sensors may vary depending on the location of the deformation sensors on the robot.

The preceding description is provided to enable any person skilled in the art to practice the various embodiments described herein. The examples discussed herein are not limited to the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A deformation sensor comprising:
a plurality of three-dimensional (3D) objects arranged on a deformable membrane, each 3D object comprising two or more colored parts, wherein the colored parts comprise two or more colors, and at least one pair of neighbor colored parts comprises different colors; and
an optical sensor configured to image the 3D objects to determine a deformation of the deformable membrane based on a color distribution of the 3D objects.

2. The deformation sensor of claim 1, wherein the color distribution of the 3D objects comprises one or more captured colors for each 3D object, and the one or more captured colors of a corresponding 3D object depend on an orientation angle between the optical sensor and the corresponding 3D object.

3. The deformation sensor of claim 2, wherein the one or more captured colors of the corresponding 3D object are a subgroup of the colors of the corresponding 3D object.

4. The deformation sensor of claim 2, wherein the deformation sensor is configured to determine a proximity depth of the corresponding 3D object based on the one or more captured colors of the corresponding 3D object.

5. The deformation sensor of claim 1, wherein each 3D object comprises a base part and an optical part, the base part comprising the two or more colored parts, the optical part configured to cause an angle-dependent color viewing based on reflection, refraction, diffraction, or a combination thereof.

6. The deformation sensor of claim 5, wherein the optical part comprises a concave shape, a convex shape, a pyramid shape, a dome shape, or a faceted shape.

7. The deformation sensor of claim 1, wherein the 3D objects have 3D shapes comprising a polyhedron shape, a tetrahedron shape, a polygonal base pyramid shape, or a combination thereof, and each colored part is a facet of the 3D shapes.

8. The deformation sensor of claim 1, wherein the 3D objects are disposed within a medium.

9. The deformation sensor of claim 8, wherein the medium comprises air, latex, silicone, acrylic, plastics, polycarbonate, opaque plastics with embedded particles, ceramics, or a combination thereof.

10. The deformation sensor of claim 1, wherein
the deformation sensor further comprises a housing having a bottom surface, the bottom surface and the deformable membrane defining a cavity therein; and
the 3D objects are disposed within the cavity.

11. The deformation sensor of claim 1, wherein the deformation sensor is mechanically coupled to a robot.

12. A method for measuring a deformation using a deformation sensor comprising:
imaging, using an optical sensor, a color distribution of a plurality of three dimensional (3D) objects disposed on a deformable membrane, each 3D object comprising two or more colored parts, wherein:
the colored parts comprise two or more colors,
at least one pair of neighbor colored parts comprises different colors, and
the color distribution comprises one or more captured colors for each 3D object;
generating real-time proximity depths of the 3D objects based on the color distribution of the 3D objects; and
determining a deformation of the deformable membrane at least partially based on the real-time proximity depths and historical proximity depths of the 3D objects.

13. The method of claim 12, wherein the one or more captured colors of a corresponding 3D object depend on an orientation angle between the optical sensor and the corresponding 3D object.

14. The method of claim 12, wherein the one or more captured colors of a corresponding 3D object is a subgroup of the colors of the corresponding 3D object.

15. The method of claim 12, wherein each 3D object comprises a base part and an optical part, the base part comprising the two or more colored parts, the optical part configured to cause an angle-dependent color viewing based on reflection, refraction, diffraction, or a combination thereof.

16. The method of claim 15, wherein the optical part comprises a concave shape, a convex shape, a pyramid shape, a dome shape, or a faceted shape.

17. The method of claim 12, wherein the 3D objects have 3D shapes comprising a polyhedron shape, a tetrahedron shape, a polygonal base pyramid shape, or a combination thereof, and each colored part is a facet of the 3D shape.

18. The method of claim 12, wherein the 3D objects are disposed within a medium, the medium comprising air, latex, silicone, acrylic, plastics, polycarbonate, opaque plastics with embedded particles, ceramics, or a combination thereof.

19. The method of claim 12, wherein
the deformable membrane is coupled to a bottom surface, the bottom surface and the deformable membrane defining a cavity therein; and
the 3D objects are disposed within the cavity.

20. The method of claim 12, wherein the 3D objects and the deformable membrane are mechanically coupled to a robot.
